(19) United States
(12) Patent Application Publication
(10) Pub. No.: US 2010/0205627 A1
(43) Pub. Date: Aug. 12, 2010

(54) Method of generating revenue from broadcasted program(s)

(76) Inventor: Eftim Cesmedziev, San Pedro, CA (US)

Correspondence Address: Eftim Cesmedziev, 326 S. Miraleste Drive 198, San Pedro, CA, 90732, US

(21) Appl. No.: 12/378,220

(22) Filed: Feb. 12, 2009

(51) Int. Cl. H04N 7/16; G06Q 30/00

(52) U.S. Cl. 725/23; 705/14.1

(57) ABSTRACT

A method of generating revenue from broadcasted program(s) is created, where code(s) is implemented to the broadcasted program(s) that allows the viewers/listeners to participate in the broadcasting program and to collect points (money) as an award for watching/listening the broadcasted program(s).

### RELATED APPLICATION

Not applicable

### STATEMENT REGARDING STATE SPONSORED RESEARCH OF DEVELOPMENT

Not applicable

### NOTICE OF MATERIAL SUBJECT TO COPYRIGHT PROTECTION

A portion of the material in this patent document is subject to copyright protection under the copyright laws of the United States of America and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R., section 1.14.

### FIELD OF INVENTION

The present invention generally relates to broadcasting production, and more specifically, to method of generating revenue from broadcasted programs.

### BACKGROUND OF THE INVENTION

Broadcasting programs in today's technology may be done through a regular TV broadcasting, cable and satellite TV broadcasting, through internet technology, as well through regular radio, satellite radio, and the like. Regardless of the broadcasting medium that is used, the message that is presented to the viewer and/or listener is directed from the broadcasted media to the viewer/listener. This one way communication is especially important to the companies that advertise their product(s) and/or service(s) through the broadcasting media(s). They pay a big money for that and they expect a financial result from the advertising in broadcasting media(s). But, there are problems that need to be addressed. One of the problems is that viewer/listener is not always around the broadcasting media, so they may miss easily the broadcasted advertising message. That is not good for the companies that advertise its product(s) and/or service(s) because that means fewer revenues for them. Therefore, the effectiveness of the advertisements is low. Also, there is a question that needs to be answered: why the viewer/listener needs to watch and/or listen the broadcasted programs if he/she does not have interest in it? Why they needs to be informed for product(s) and/or service(s) that they do not need them? Is it any benefit for the viewer/listener to watch/listen the broadcasted programs? Why the message is directed only one way, but not two ways, which includes the direction from the viewer and/or listener to the broadcasting media?

Currently, there is a lack of a reliable revenue structure and business model in the broadcasting program that address these issues and find solution to solve these problems. Therefore, an object of the present invention is to provide a new business model for generating revenue. With implementing of this invention, above mentioned limitations will be eliminated and will give a dynamic development in relations between all involved parts where participants will be awarded for watching the broadcasted program(s).

### BRIEF SUMMARY OF THE INVENTION

The general purpose of the present invention, which will be described subsequently in detail later, is to provide method of generating revenues from broadcasted program(s), heretofore as a prior art and novel features that which is not anticipated, rendered obvious, suggested, or even implied by any of the prior art, either alone or in any combination thereof.

Moreover, one embodiment of the present invention includes program that is broadcasted on different medias, including but not limited to regular TV, satellite TV, cable TV, internet that is able to reach certain web site, regular radio, satellite radio, any hand held device and any other media, where the broadcasted program can by reached by the viewer/listener using any media successfully and adequately without any limitation. In order for viewer/listener to watch, listen and interact with the broadcasted program, he/she need to have adequately and successfully connected all required hardware and software that are known in the prior art of the industry.

Another embodiment of the present invention includes mandatory registration of the viewers who want to participate in the broadcasted program, using any medias, where viewer can log in and create personal and secure file with database according the rules and requirements of the broadcasted program. All responses of the viewers/listeners are collected, analyzed, selected, eliminated and/or kept by the central data receiving center, supported by a multy-media, multy-network server for qualification for the points based on predefined rules for the award of points to the participating viewers, as is well known in prior art.

Another embodiment of the invention is that on every broadcasted program is implemented a code, which can be clearly seen and/or heard by the participant. That code participant must to remember and to enter it to his/her account. With entering the code to his/her account, the participant collects points. There is a list of product(s) and/or service(s) where participant may see how many point he/she needs for that product(s) and/or service(s). Also, there may be implemented some kind of elimination game and/or show where participant will be selected by elimination of other. This is done in case if there are more participant then product(s) and/or service(s) available.

Another embodiment of the present invention includes personal code for every participants. For example, after the registration, every participant may call certain phone number, where after dialing the number they need to enter their personal code, for example the phone number that are calling from. In that way for security reasons, the number may be checked and personal account may be reached. After that, the participant may be asked to enter the code implemented on the broadcasted media. After this process, the central multy-media data receiving center devises adequately and functionally collect, analyzed, select, eliminate and/or kept the answers of the participants. Every answer of the participant means some points, which are securely and adequately add to the participant account. Every participant can log in to his/her account and see the earned points. There is a list of awards for certain number of points, where every participant can see what he/she can get for that number of earned points, or can see how many more points need to collect in order to get desired product(s) or service(s).

Another embodiment of the present invention is that allows unlimited numbers of viewers/listeners to participate in the broadcasted program. Every broadcasted program may have different rules and requirements for the participant. The rules and the requirements of the broadcasted program are presented to every participant where every participant is required to accept all rules and requirements regardless of its natures. Every rule is closely monitored by a number of judges for its correctness.

Another embodiment of the invention includes product(s) and service(s) from the advertising companies that are actively included in the broadcasted program. In order to increase the advertising revenue, the broadcasted program may include in its program an advertising product(s) and service(s), where viewers/listeners will not only see/hear the product(s) and/or service(s) that are advertised, but to implement them in their life, as a part of the broadcasted program request for that certain level.

Another embodiment of the invention is that advertising companies who are sponsoring the broadcasting program(s) may collect answers from the participant in the broadcasting program, based on their lives and needs or other fields of interest that are valuable for the product(s) and service(s) that companies provides. In this way advertising companies will have a clearer picture for the daily needs that are constantly changing based of the real life of the participant. Those advertising companies who participate in the broadcasting program may receive personal information about the participant in the program.

In this respect, before explaining at least one embodiment of the invention in greater detail, it is to understand that invention is not limited in its application to the details and steps of construction and to arrangements of the components/steps set forth in the following description. The invention is capable of other embodiments and of being practiced and carried out in various ways. In addition, it is to be understood that the phraseology and terminology employed herein is for the purpose of description and should not be regarded as limiting.

As such, those skilled in the art will appreciate that the conceptions, upon which this disclosure is based, may readily be utilized as a basis for the designing of other structures, devices, methods and systems for carrying out the several purposes of the present invention. It is important, therefore; that the claims be regarded as including such equivalent constructions insofar as they do not depart from the spirit and scope of the present invention.

Further, the purpose of the foregoing abstract is to enable the Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

### DEFINITIONS OF TERMS

The term “participant” herein denotes an individual person or a group of people who are involved in the broadcasted program(s) according to the present invention.

The term “broadcasted program” and “program” herein denotes a program(s) that is broadcasted at any media. The broadcasted program(s) may include news, talking shows, series of episodes, advertising commercials, weather reports, live events, and the like, and any program that is broadcasted by any medias. The broadcasted program(s) may be broadcasted on any media, including but not limited to TV, internet that is able to reach certain web site, any hand held device, radio, cable and satellite TV and/or any other combination between any medias known in the prior art.

The term “registration” herein denotes process of creating a personal secure file with data already know in the prior art, where viewer participant must to fulfill a number of requirements and to have technological knowledge to use adequately and successfully any device required by the rules and requirements.

The term “code” herein denotes any letter/letters, sign/signs, number/numbers, sound/sounds, color/colors, picture/pictures, and the like, and any combination between them, that are implemented in the broadcasted program. Every broadcasted program has different code. That code is needed for participant to collect points, as an award that he/she is watching/listening the broadcasted program.

### DETAILED DESCRIPTION OF THE PREFERRED EMBODIMENTS

Aspects of the invention may be practiced using any suitable arrangement of the elements of the invention. However, it should be understood that these illustrative embodiments of the invention should not be used to narrowly interpret the scope of the invention.

As an embodiment of the invention, there are few basic steps that are connected together adequately and successfully as an one unit, where:

a) program is created to be broadcasted through any media known in the prior art;

b) a phone number(s) and/or web address(es) together with a code(s) are implemented to the program, where viewers/listeners may see/hear them on the broadcasted media;

c) people are invited to be participant in the broadcasted program where all information for enrollment to it are provided for them;

d) people follow the requirements for registration at certain media using adequately and functionally devices already known in the prior art;

e) after successful registration of the participant, he/she has own personal secure account with data base protected adequately and functionally by security device(s), where he/she receive personal secure name;

f) the personal secure name is made from combination of number(s) and/or letter(s) and/or symbol(s);

g) when participant watch/listen a certain media where a broadcasted program is broadcasted, he/she will see a phone number(s) and/or web address(es) and code(s) implemented adequately and successfully at the broadcasted program;

h) then, participant must to use adequately and functionally a device(s) that allowed adequate and successful connection to that phone number(s) and/or web address(es);

i) then, participant access that phone number(s) and/or web address(es), where he/she need to enter its own personal secure name in order to successfully log in to its own personal secure account with data base;

j) after successful log in to its account, participant adequately and successfully enter the code(s) implemented at the broadcasted program, where central data receiving center, supported by a multy-media, multy-network server(s) adequately and successfully collect and remember all participant entries followed by supported information, such as, but not limited to the date and the time of entering the information;

k) every entered code(s) by the participant to its personal secure account, allowed him/her to collect a points/money which are adequately and securely saved at his/her personal account;

l) every personal secure account has up to date correct information about all activity of the participant together with list of items that he/she can have it for the collected points/money;

m) participant can use adequately and successfully its points/money at any time;

n) when participant collect enough points, he/she can choose the price that comes with that numbers of points/money, or collect more for better prize;

o) steps from g) to n) may be repeated by the participant unlimited times, where every code(s) implemented at the broadcasted program may be entered ones at same account;

p) if there are more participants with enough points/money for the same prize, then a selecting game may be implemented for selecting the winner, such as, but not limited to puzzle, answers and questions, to ask the participant to do something, to use some product(s) and service(s), and the like.

One embodiment of the present invention includes program that is broadcasted on different medias, including but not limited to regular TV, satellite TV, cable TV, internet that is able to reach certain web site, regular radio, satellite radio, any hand held device and any other media, where the broadcasted program can by reached by the viewer/listener using any media successfully and adequately without any limitation. In order for viewer/listener to watch and interact with the broadcasted program, he/she need to have adequately and successfully connected all required hardware and software that are known in the prior art of the industry.

Every participant must to pass mandatory registration process, using adequately and successfully any known medias, where participant can reach a certain web site, log in into it and create personal and secure account with database according the rules and requirements of the broadcasted program. All responses of the participants are collected, analyzed, selected, kept and/or eliminated by the central data receiving center, supported by a multy-media, multy-network server for qualification for the points based on predefined rules for the award of points to the participating viewers, as is well known in prior art. All personal information is protected adequately by security devices. Collected information is available only to the broadcasting program supporters, such as advertising companies, program development agencies, and the like.

One embodiment of the invention is that on every broadcasted program there is implemented a code(s), which can be clearly seen and/or heard by the participant. That code(s), participant must to remember and to enter it to his/her account. The implemented code(s) is made from combination of number(s) and/or letter(s) and/or symbol(s).

One embodiment of the present invention includes a phone number(s) and/or web address(es) that are implemented adequately and successfully at the broadcasted program. That phone number(s) and/or web address(es), participant must to remember and to enter it to his/her account. The implemented phone number(s) and/or web address(es) is made from combination of number(s) and/or letter(s) and/or symbol(s);

Another embodiment of the present invention is that allows unlimited numbers of viewers/listeners to participate in the broadcasted program. Every broadcasted program may have different rules and requirements for the participant. The rules and the requirements of the broadcasted program are presented to every participant where every participant is required to accept all rules and requirements regardless of its natures. Every rule is closely monitored by a number of judges for its correctness.

Another embodiment of the invention is that advertising companies who are sponsoring the broadcasting program may collect answers from the participants in the broadcasting program, based on their lives and heeds or other fields of interest that are valuable for the products and services that companies provides. In this way advertising companies will get clearer picture for the daily needs that are constantly changing based of the real life of the participant. Advertising companies gives points to the participants, which can be translated to money. In that case participants get more points if they buy product(s) and/or service(s) from them, and less if they just watch/listen the commercials.

Another embodiment of the invention is that advertising companies who are giving the points/money to the winning participants, may offer them discounts on its product(s) and/or service(s), money and/or other goods that participants need it.

Having described the principles of my invention, it should be apparent that these steps of the invention are basic steps and that more steps may be added within the method. From the foregoing, it will be appreciated that, although specific embodiments of the invention have been described herein for the purposes of illustration, various modifications may be made without deviating from the spirit and scope of the invention. Accordingly, I claim all steps and modifications as many come within the scope and spirit of the following claims.

I claim:

1. Method of generating revenues from broadcasted program(s) comprising:
a) program is created to be broadcasted through any media known in the prior art;
b) a phone number(s) and/or web address(es) together with a code(s) are implemented adequately and successfully to the program, where viewer(s)/listener(s) may see/hear them on the broadcasted media(s);
c) people are invited to be participants in the broadcasted program(s) where information for enrollment are provided for them;
d) people follow the requirements for registration at certain media using adequately and functionally devices already known in the prior art;
e) after successful registration of the participant, he/she has own personal secure account with data base protected adequately and functionally by security device(s), where he/she receive personal secure name;
f) the personal secure name is made from combination of number(s) and/or letter(s) and/or symbol(s);
g) when participant watch/listen a certain media where a broadcasted program(s) is broadcasted, he/she will see a phone number(s) and/or web address(es) and code(s) implemented adequately and successfully at the broadcasted program(s);
h) then, participant must to use adequately and functionally a device(s) that allowed adequate and successful connection to that phone number(s) and/or web address(es);
i) then, participant access that phone number(s) and/or web address(es), where he/she need to enter its own personal secure name in order to successfully log in to its own personal secure account data base;
j) after successful log in to its own account, participant adequately and successfully enter the code(s) implemented at the broadcasted program, where central data receiving center, supported by a multy-media, multy-network server(s) adequately and successfully collect and remember all participant entries followed by supported information, such as, but not limited to the date and the time of entering the information;
k) every entered information by the participant to its personal secure account, allowed him/her to collect a points/money which are adequately and securely saved at his/her personal account;
l) every personal secure account has up to date correct information about all activity of the participant together with list of item that he/she can have it for the collected points/money;
m) participant can use adequately and successfully its points/money at any time;
n) when participant collect enough points, he/she can choose the price that comes with that numbers of points/money, or collect more for better prize;
o) steps from g) to n) may be repeated by the participant many times, where every code implemented at the broadcasted program may be entered ones at same account;
p) if there are more participants with enough points/money for the same prize, then a selecting and/or eliminating game may be implemented for selecting the winner, such as, but not limited to puzzle, answers and questions, to ask the participant to do something, to use some product(s) and service(s), and the like;
q) all steps of the method are connected together adequately and successfully as an one working unit.

2. A method as recited in claim 1, wherein said broadcasted program further includes broadcasted program, where:
a) broadcasted program is broadcasted on different medias, including but not limited to regular TV, satellite TV, cable TV, internet that is able to reach certain web site, regular radio, satellite radio, any hand held device and any other media, where the broadcasted program can by reached by the viewer/listener using any media successfully and adequately without any limitation;
b) broadcasted program(s) may include news, talking shows, series of episodes, advertising commercials, weather reports, live events, and the like, and any program that is broadcasted by any medias;
c) a code(s) is implemented in broadcasted program(s), which can be clearly seen and/or heard by the participant, and the implemented code(s) is made from combination of number(s) and/or letter(s) and/or symbol(s);
d) a phone number(s) and/or web address(es) are implemented adequately and successfully at the broadcasted program, and the implemented phone number(s) and/or web address(es) are made from combination of number(s) and/or letter(s) and/or symbol(s);
e) broadcasted program(s) allows unlimited numbers of viewers/listeners to participate in the broadcasted program;
f) broadcasted program(s) has advertising companies that gives points to the participants, which can be translated to money, where participants can get more points if they buy product(s) and/or service(s) from them, and less if they just watch/listen the commercials;
g) broadcasted program(s) may have different rules and requirements for the participant, where rules and the requirements of the broadcasted program are presented to every participant where every participant is required to accept all rules and requirements regardless of its natures;
h) broadcasted program(s) has advertising companies who are sponsoring the broadcasting program may collect answers from the participants in the broadcasting program, based on their lives and needs or other fields of interest that are valuable for the products and services that companies provides. In this way advertising companies will get clearer picture for the daily needs that are constantly changing based of the real life of the participant;
i) broadcasted program(s) advertising companies who are giving the points/money to the winning participants, may offer them discounts on its product(s) and/or service(s), money and/or other goods that participants need it;
j) where every rule is closely monitored by a number of judges for its correctness.

3. A method as recited in claim 1, wherein said participant further includes participant, where:
a) participant need to have adequately and successfully connected all required hardware and software that are known in the prior art of the industry;
b) participant must to pass mandatory registration process, using adequately and successfully any known medias, where participant can reach a certain media, log in into it and create personal and secure account with database and must to accept the rules and requirements of the broadcasted program;
c) participant must to agree that all responses of the participants are collected, analyzed, selected, kept and/or eliminated by the central data receiving center, supported by a multy-media, multy-network server for qualification for the points based on predefined rules for the award of points to the participating viewers, as is well known in prior art;
d) participant may see how many point he/she needs for certain product(s) and/or service(s) form list of product(s) and/or service(s) available on his/her personal secure account;
e) every answer of the participant means some points, which are securely and adequately add to the participant account, where every participant can log in to his/her account and see the earned points.
f) participant may play some kind of elimination game if there are more participants then product(s) and/or service(s) available certain product(s) and/or service(s) or for other reasons;

4. A method as recited in claim 1, wherein said code(s) further includes code(s) that is created from any letter/letters, sign/signs, number/numbers, sound/sounds, color/colors, picture/pictures, and the like, and any combination between them, and are implemented adequately and functionally in the broadcasted program(s), where every broadcasted program(s) may have different code.

5. A method as recited in claim 1, wherein said phone number(s) and/or web address(es) further includes phone number(s) and/or web address(es) that is created from any letter/letters, sign/signs, number/numbers, sound/sounds, color/colors, picture/pictures, and the like, and any combination between them, and are implemented adequately and functionally in the broadcasted program(s), where every broadcasted program(s) may have different phone number(s) and/or web address(es).

6. A method as recited in claim 1, wherein said broadcasted program(s) further includes broadcasted program(s) that is advertising commercial broadcasted, where:
a) advertising commercial is created to be broadcasted through any known media known in the prior art;
b) a phone number(s) and/or web address(s) together with a code(s) are implemented to the advertising commercial, where viewers/listeners may see/hear them on the broadcasted media(s);
c) people are invited to be participant in the advertising commercial where all information for enrollment to it are provided for them;
d) people follow the requirements for registration at certain media using adequately and functionally devices already known in the prior art;
e) after successful registration of the participant, he/she has own personal secure account with data base protected adequately and functionally by security device(s), where he/she receive personal secure name;
f) the personal secure name is made from combination of number(s) and/or letter(s) and/or symbol(s);
g) when participant watch/listen a certain media where an advertising commercial is broadcasted, he/she will see a phone number(s) and/or web address(es) and code(s) implemented adequately and successfully at the advertising commercial;
h) then, participant must to use a device that allowed adequate and successful connection to that phone number(s) and/or web address(es);
i) then, participant access that phone number(s) and/or web address(s), where he/she need to enter its own personal secure name in order to successfully log in to its own personal secure data base;
j) after successful log in to its account, participant adequately and successfully enter the code implemented at the advertising commercial, where central data receiving center, supported by a multy-media, multy-network server(s) adequately and successfully collect and remember all participant entries followed by supported information, such as, but not limited to the date and the time of entering the information;
k) every entered code(s) by the participant to its personal secure account, allowed him/her to collect a points/money which are adequately and securely saved at his/her personal account;
l) every personal secure account has up to date correct information about all activity of the participant together with list of item that he/she can have it for the collected points/money;
m) participant can use adequately and successfully its points/money at any time;
n) when participant collect enough points, he/she can choose the price that comes with that numbers of points/money, or collect more for better prize;
o) steps from g) to n) may be repeated by the participant many times, where every code implemented at the advertising commercial may be entered ones at same account;
p) if there are more participants with enough points/money for the same award, then a selecting and/or eliminating game may be implemented for selecting the winner, such as, but not limited to award, answers and questions, to ask the participant to do something, to use some product(s) and service(s), and the like.
